(19) United States
(12) Patent Application Publication
(10) Pub. No.: US 2005/0160256 A1
(43) Pub. Date: Jul. 21, 2005

(54) [REMOTE BOOT METHOD AND DEVICE THEREOF AND SERVER DEVICE USING REMOTE BOOT METHOD]

(76) Inventors: Chien-Shan Huang, Taipei Hsien (TW); Sen-Ta Chan, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,825

(22) Filed: Jun. 1, 2004

(30) Foreign Application Priority Data
Jan. 16, 2004 (TW) 93101131

(51) Int. Cl. G06F 15/177; G06F 9/00

(52) U.S. Cl. 713/2

(57) ABSTRACT

A method and a device for remote boot and a server device using the same are provided. The method for remote boot includes the following steps. First, a computer having a network boot device is powered. Then, a loader program is downloaded by the network boot device, and then a configuration file having a size of an allocated memory and a file list is downloaded. Next, a memory block on the computer is allocated according to the size of the allocated memory, and a file system is installed in the memory block. Thereafter, a file is downloaded to the file system according to the file list; and a virtual disk drive is installed in the computer according to the file system. Thus, the computer may be boot via the virtual disk drive.

### CROSS REFERENCE TO RELATED APPLICATIONS

This application claims the priority benefit of Taiwan application serial no. 93101131, filed Jan. 16, 2004.

### BACKGROUND OF INVENTION

1. Field of the Invention

This invention generally relates to a remote boot method and a device thereof. More particularly, the invention relates to a remote boot method and a device thereof and server devices using the remote boot method.

2. Description of the Related Art

In recently years, the remote boot method and device of computer systems have become more important and popular. For example, in a server system, since the traditional server is gradually replaced by the rack mountable server, more servers may be installed in the rack of the rack mountable server. Thus, how to effectively manage these rack mountable servers has become a serious issue. The conventional method is to setup at least a keyboard, a display, a mouse, and a KVM (keyboard-video-mouse) switch on the rack and use the KVM switch to select the specific server. In general, when a server needs to be booted by a floppy disk, the manager has to find the server and then uses the floppy disk to boot the server. If the number of servers becomes larger and larger such as tens of servers, the conventional method is not efficient for the manager.

Moreover, the blade server developed in recent years may provides more servers in a server system in comparison with the rack mountable servers since CD-ROM drive or floppy drive is no more required and main board, CPU, hard disk, and memory can be integrated in a single interface card. In other words, the blade server has a smaller size and a higher density than that of a rack mountable server, therefore, more blade servers may be installed in a rack. Therefore, a remote boot method is more preferable for the management of the system of blade servers.

Currently, the remote boot of the servers can be implemented by several ways. For example, the manager can use the Boot ROM on the network card to perform the remote boot of the server. First of all, a preset program code is burnt into the Boot ROM of the network card. When the computer is powered on, the BIOS of the computer is executed. If the Boot ROM is detected by the BIOS, the BIOS will transfer the authority to the program code in the Boot ROM and to execute the program code. When the program code is executed, the network card is forced to download the image files into the memory of the computer and then the image files are used to perform the remote boot of the computer.

In addition, remote boot can also be implemented by using preboot execution environment (PXE) standard module. First of all, a standard PXE program code is burnt in the Boot ROM of the network card or in the BIOS. When the computer is powered on, the BIOS is executed. If the computer is set to be booted from the PXE program code, the BIOS will transfer the authority to the PXE program code and then the PXE program code is executed. When the PXE program code is executed, the network is forced to get the IP addresses of the local computer and the trivial file transfer protocol (TFTP) server via the dynamic host configuration protocol (DHCP) server on the net. Then, the boot image files are downloaded from the TFTP server to the memory of the local computer. Then, the local computer is booted by the boot image files.

Another way to implement the remote boot of the server is to provide the remote boot by a stand-alone system. The stand-alone system may include main board, CPU, hard disk, memory, I/O port, display and network card. In other words, the stand-alone system may be a stand-alone computer system. Before the computer is booted, the stand-alone system is still operated and can detect the current condition of the computer. When the boot of the computer is detected by the stand-alone system, the boot image files are download into the memory of the stand-alone system and performed as a virtual floppy disk so that the local computer can be booted by the virtual floppy disk.

Accordingly, all the conventional remote boot procedure described above may be described by the flowchart shown by FIG. 1. FIG. 1 is a flowchart schematically illustrating a conventional method for remote boot. Referring to FIG. 1, after the computer is booted in step S102, the BIOS of the computer is executed in step S104. Then, the BIOS transfers the authority to the network boot device such as the Boot ROM, the PXE program code, or the stand-alone system in step S112. Then, the boot image files download the loader program in step S108, and the loader program is executed in step S110. The loader program downloads the boot image files (for example, the boot image files downloaded by the Boot ROM, the PXE program code or the sand-alone system) to the memory of the local computer in step S112. Thereafter, the boot image files is executed to setup a virtual disk drive in step S114. Then, the local computer can use this virtual disk drive to perform the remote boot in step S116.

FIG. 2 is a diagram schematically illustrating a memory block for a conventional boot image file for remote boot. In the conventional remote boot procedure shown in FIG. 1, after the loader program is executed, a memory block is used by the loader program and is divided into a plurality of sub-blocks to setup such as the boot sector 202, the file allocation table (FAT) 208, the directory 209, and the files 210. Conventionally, the memory size and address of each sub-block is preset and cannot be modified. Therefore, the installation of the files and the virtual disk drive in the memory is unchangeable.

Accordingly, the conventional remote boot method and device have at least the disadvantages described below. First, the whole set of boot image files needs to be downloaded. In general, the size of boot image files stored in a floppy disk drive is, for example, up to 1.44 MB. In other words, in the remote boot procedure, the boot image files of 1.44 MB or more is required to be downloaded via network at each time of remote boot. In addition, the size and installation of the boot image files are fixed and cannot be changed directly. Therefore, the installation of the files and the virtual disk drive in the memory is unchangeable. Therefore, a flexible remote boot method and device suitable for a server system are required.

### SUMMARY OF INVENTION

The present invention provides a remote boot method and device with a file system that can create a virtual disk drive according to the requirement of the user. Thus, the size and installation of the virtual disk drive and files for remote boot may be adjusted by the user.

In addition, the present invention provides a server device for remote boot with a file system that can create a virtual disk drive according to the requirement of the user. Thus, the size and installation of the virtual disk drive and files for remote boot may be adjusted by the user.

The present invention provides a method for remote booting a computer. The method includes the following steps. First, a basic input output system (BIOS) is executed for determining whether to execute a remote boot procedure. Then, a loader program is downloaded and executed when the remote boot procedure is executed. Next, a configuration file including a size of an allocated memory and a file list is downloaded. Thereafter, a memory block is allocated on the computer according to the size of the allocated memory and a file system is installed in the memory block. Thus, a file is downloaded to the file system according to the file list. In one embodiment of the invention, a virtual disk drive is installed in the computer according to the file system, and thus the computer is booted via the virtual disk drive.

In addition, the present invention provides a computer suitable of remote boot. The computer includes, for example but not limited to, a network boot device for downloading a loader program via a network. The loader program downloads a configuration file having a size of an allocated memory and a file list. Then, the loader program setups a memory block on the computer according to the size of the allocated memory and setups a file system in the memory block. Thus, a file is downloaded into the file system according to the file list. In one embodiment of the invention, a virtual disk drive is installed in the computer according to the file system, and thus the computer is booted via the virtual disk drive.

In one embodiment of the present invention, the network boot device includes, for example but not limited to, a boot read only memory (Boot ROM) on a network card, a preboot execution environment (PXE) standard module or a stand alone system.

In one embodiment of the present invention, the file system includes, for example but not limited to, a boot sector, a file allocation table, a directory, and the file.

Moreover, the present invention further provides a server device for remote boot. The server device includes, for example but not limited to, a server and a network boot device for downloading a loader program via a network. The loader program downloads a configuration file having a size of an allocated memory and a file list. Then, the loader program setups a memory block on the server device according to the size of the allocated memory and setups a file system in the memory block. Thus, a file is downloaded into the file system according to the file list. In one embodiment of the invention, the file is used to install a virtual disk drive in the server device and the virtual disk drive boots the server device.

In a preferred embodiment of the present invention, the server device comprises, for example but not limited to, a rack mountable server, a blade server, or a double-CPU server.

Accordingly, the method and device for remote boot of the present invention can setup a file system according to the configuration system, and thus has the advantages described below. First, in the present invention, the installation of the virtual disk drive is changeable. In addition, the installation of files for remote boot are also changeable, and thus the size of the memory used in remote boot may be minimized by only installing essential files for remote boot, and thus the time for downloading the files are reduced. In summary, the file system of the present invention can create a virtual disk drive according to the requirement of the user, and thus the size and installation of the virtual disk drive and files for remote boot may be adjusted by the user.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a flowchart schematically illustrating a conventional method for remote boot.

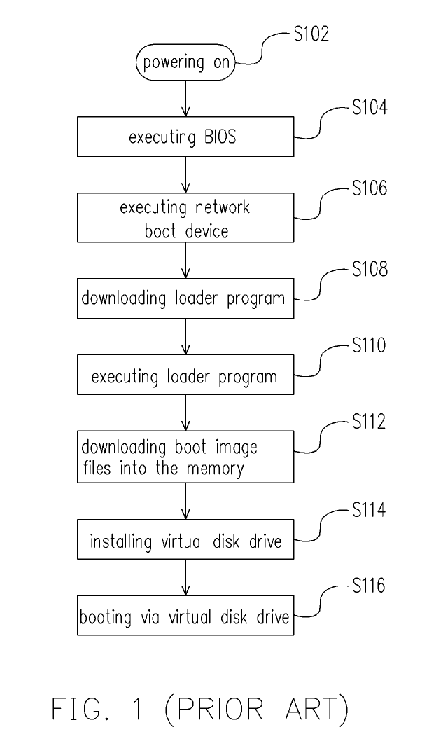

FIG. 2 is a diagram schematically illustrating a memory block for a conventional boot images file for remote boot.

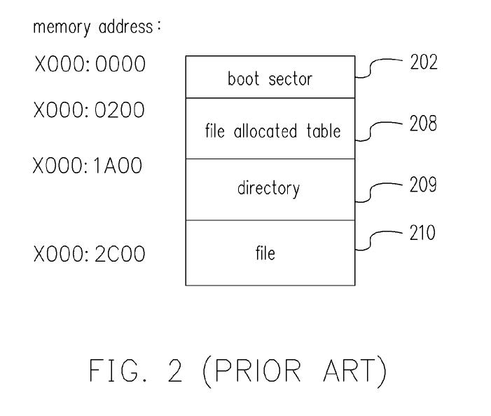

FIG. 3 is a flowchart illustrating a remote boot procedure according to an embodiment of the present invention.

FIG. 4 is a diagram schematically illustrating a memory block for boot image files for remote boot according to an embodiment of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

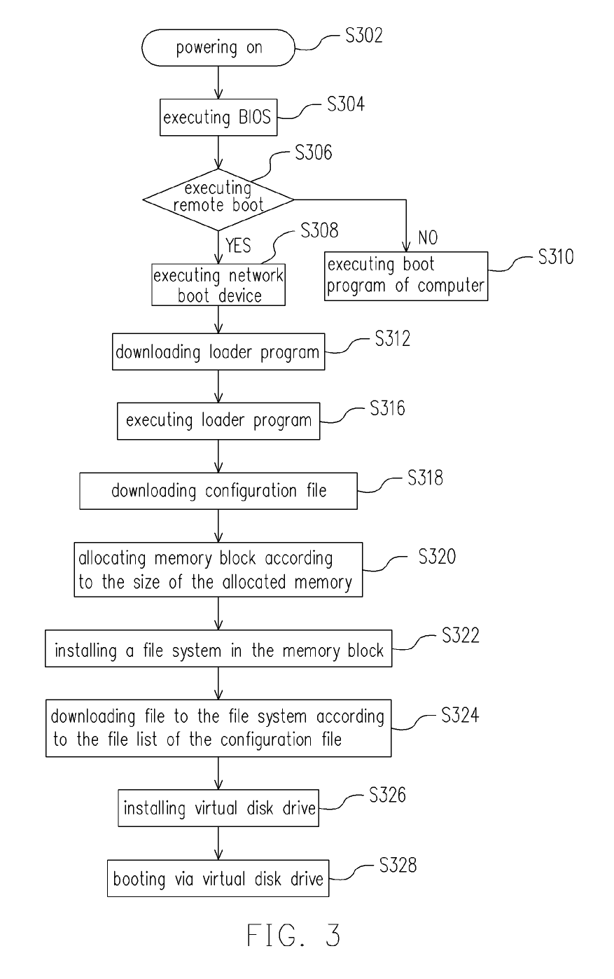

FIG. 3 is a flowchart illustrating a remote boot procedure according to an embodiment of the present invention. As shown in FIG. 3, the computer is powered on in step S302. Then, the BIOS of the computer is executed in step S304 to detect and initialize the computer. In step S306, the computer will determine the boot procedure according to the detection and initialization of the BIOS. For example, if a remote boot device such as Boot ROM, PXE program code or a stand alone system is detected to be previously installed in the computer, the BIOS executes the network boot device in step S308. Otherwise, the BIOS will boot the computer itself and execute the boot procedure in step S310. After step S308, the network boot device initializes the network and download the loader program via the network in step S312. Then, in step S316, the loader program executes the loader program. Then a configuration file of the computer is downloaded by the loader program in step S318. The configuration file may be, for example, a text file (.TXT). The size of the allocated memory and the file list required for the remote boot is preset in the configuration file. Then, a memory block is allocated according to the size of the allocated memory in step S320. Thereafter, a file system is installed in the memory block in step S322. Thus, files corresponding to the file list are downloaded to the file system in step S324. Therefore, a virtual disk drive is installed in step S326, and the remote boot is performed by the virtual disk drive in step S328.

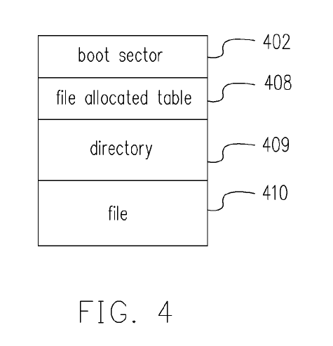

FIG. 4 is a diagram schematically illustrating a memory block for boot image files for remote boot according to an embodiment of the present invention. In the remote boot procedure shown in FIG. 3, after the configuration file is downloaded in step S318, the memory block is allocated according to the size of the allocated memory in the configuration file in step S320 and a file system is installed in the memory block in step S322. Referring to FIG. 4, the file system may include, for example but not limited to, a boot sector 402, a file allocated table (FAT) 408, a directory 409 and files 410. The size and address of the memory block, sub-blocks and files are setup according to the configuration file. Therefore, the download of the files and the setup of the virtual disk drive may be preset by setting the configuration file. For example, the size of conventional boot image files used in a floppy disk drive is about 1.44 MB. Therefore, in each conventional remote boot process, the computer needs to download the conventional boot image files of about 1.44 MB via the network. However, in one embodiment of the present invention, the size of the files required for the remote boot procedure may be reduced to about, for example but not limited to, 131 KB or less. Accordingly, the space of the virtual disk drive is minimized and the speed of the remote boot procedure via the network is enhanced.

Accordingly, the method and device for remote boot of the present invention can setup a file system according to the configuration system, and thus has the advantages described below. First, in the present invention, the installation of the virtual disk drive is changeable. In addition, the installation of files for remote boot are also changeable, and thus the size of the memory used in remote boot may be minimized by only installing essential files for remote boot, and thus the time for downloading the files are reduced. In summary, the file system of the present invention can create a virtual disk drive according to the requirement of the user, and thus the size and installation of the virtual disk drive and files for remote boot may be adjusted by the user.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for remote booting a computer, comprising:
executing a basic input output system (BIOS) and determining whether to execute a remote boot procedure;
downloading and executing a loader program when the remote boot procedure is executed;
downloading a configuration file, wherein the configuration file comprising a size of an allocated memory and a file list;
allocating a memory block on the computer according to the size of the allocated memory and installing a file system in the memory block; and
downloading a file to the file system according to the file list.

2. The method of claim 1, wherein after the step of downloading the file to the file system according to the file list, further comprising:
installing a virtual disk drive in the computer according to the file system and booting the computer via the virtual disk drive.

3. The method of claim 1, wherein the file system comprises a boot sector, a file allocation table, a directory, and the file.

4. The method of claim 1, wherein the step of determining whether to execute a remote boot procedure depends on a setting of the BIOS.

5. A computer suitable of remote boot, comprising:
a network boot device for downloading a loader program via a network, wherein the loader program downloads a configuration file having a size of an allocated memory and a file list, the loader program setups a memory block on the computer according to the size of the allocated memory and setups a file system in the memory block, and a file is downloaded into the file system according to the file list.

6. The computer of claim 5, wherein the file is used to install a virtual disk drive in the computer, and the virtual disk drive boots the computer.

7. The computer of claim 5, wherein the network boot device comprises a boot read only memory (Boot ROM) on a network card.

8. The computer of claim 5, wherein the network boot device comprises a preboot execution environment (PXE) standard module.

9. The computer of claim 5, wherein the network boot device comprises an stand alone system.

10. The computer of claim 5, wherein the file system comprises a boot sector, a file allocation table, a directory, and the file.

11. A server device for remote boot, comprising:
a server; and
a network boot device for downloading a loader program via a network, wherein the loader program downloads a configuration file having a size of an allocated memory and a file list, the loader program setups a memory block on the server device according to the size of the allocated memory and setups a file system in the memory block, and a file is downloaded into the file system according to the file list.

12. The server device of claim 11, wherein the file is used to install a virtual disk drive in the server device and the virtual disk drive boots the server device.

13. The server device of claim 11, wherein the server device comprises a rack mountable server.

14. The server device of claim 11, wherein the server device comprises a blade server.

15. The server device of claim 11, wherein the server device comprises a double-CPU server.

16. The server device of claim 11, wherein the network boot device comprises a boot read only memory (Boot ROM) on a network card.

17. The server device of claim 11, wherein the network boot device comprises a preboot execution environment (PXE) standard module.

18. The server device of claim 11, wherein the network boot device comprises an stand alone system.

19. The server device of claim 11, wherein the file system comprises a boot sector, a file allocation table, a di-rectory, and the file.
